(19) United States
(12) Patent Application Publication
(10) Pub. No.: US 2024/0004595 A1
(43) Pub. Date: Jan. 4, 2024

(54) SERVER DEVICE, METHOD OF CONTROLLING SERVER DEVICE, AND PRINTING SYSTEM

(71) Applicant: SEIKO EPSON CORPORATION, Tokyo (JP)

(72) Inventors: Hiroshi KAIHO, MATSUMOTO-SHI (JP); Naohiro KANEKO, MATSUMOTO-SHI (JP); Hideaki KITAZAWA, SUWA-SHI (JP); Koji NIIOKA, KAMIINA-GUN TATSUNO-MACHI (JP)

(21) Appl. No.: 18/346,414

(22) Filed: Jul. 3, 2023

(30) Foreign Application Priority Data
Jul. 4, 2022 (JP) 2022-107683

(51) Int. Cl. G06F 3/12

(52) U.S. Cl. CPC G06F 3/121; G06F 3/1234; G06F 3/1273; G06F 3/1288

(57) ABSTRACT

A server device is a server device to be coupled to a printer so as to be able to communicate with each other, including an instruction unit configured to transmit a second instruction of making the printer perform a printing operation when an error occurs in the printer, and a first acquisition unit configured to make the printer generate a first operation log as a log related to the printing operation based on the second instruction, and obtain the first operation log from the printer.

The present application is based on, and claims priority from JP Application Serial Number 2022-107683, filed Jul. 4, 2022, the disclosure of which is hereby incorporated by reference herein in its entirety.

### BACKGROUND

### 1. Technical Field

The present disclosure relates to a server device, a method of controlling a server device, and a printing system.

### 2. Related Art

In the past, there has been known a technology of obtaining an operation log of a printer.

In, for example, JP-A-2021-135666 (Document 1), there is described an administrative server regularly obtaining an operation log of a printer.

However, in the server described in Document 1, since there are a variety of restrictions on the operation log to regularly be obtained, there is a possibility that it is not achievable to obtain information for identifying the cause of an error.

For example, in a usual operation log (e.g., an operation log regularly obtained), there is a restriction on a capacity of the operation log in order to prevent an influence on a printing operation of a printer when obtaining the operation log. Therefore, there is a possibility that there occurs an item which cannot be obtained in the usual operation log.

### SUMMARY

An aspect for solving the problems described above is a server device to be coupled to a printer so as to communicate with each other, the server device including an instruction unit configured to transmit an instruction of making the printer perform a printing operation when an error occurs in the printer, and a first acquisition unit configured to make the printer generate a first operation log as a log related to the printing operation based on the instruction, and then obtain the first operation log from the printer.

Another aspect for solving the problems described above is a method of controlling a server device to be coupled to a printer so as to communicate with each other, the method including an instruction step of transmitting an instruction of making the printer perform a printing operation when an error occurs in the printer, and a first acquisition step of making the printer generate a first operation log as a log related to the printing operation based on the instruction, and then obtaining the first operation log from the printer.

Still another aspect for solving the problems described above is a printing system including a printer, and a server device to be coupled to the printer so as to communicate with each other, wherein the server device includes an instruction unit configured to transmit an instruction of making the printer perform a printing operation when an error occurs in the printer, and a first acquisition unit configured to make the printer generate a first operation log as a log related to the printing operation based on the instruction, and then obtain the first operation log from the printer.

### BRIEF DESCRIPTION OF THE DRAWINGS

FIG. 1 is a diagram showing an example of a configuration of a printing system according to the embodiment.

FIG. 2 is a side view showing an example of a configuration of a printer according to the embodiment.

FIG. 3 is a diagram showing an example of a configuration of a first control device of the printer.

FIG. 4 is a diagram showing an example of a configuration of a server device according to the embodiment.

FIG. 5 is a diagram showing an example of a configuration of a client terminal device related to the embodiment.

FIG. 6 is a diagram showing an example of a first operation log and a second operation log.

FIG. 7 is a flowchart showing an example of processing in the server device.

### DESCRIPTION OF AN EXEMPLARY EMBODIMENT

An embodiment of the present disclosure will hereinafter be described with reference to the drawings.

### 1. Overall Configuration of Printing System

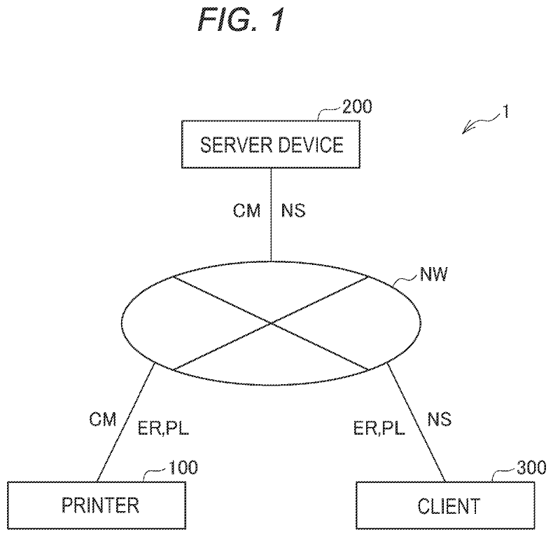

FIG. 1 is a diagram showing an example of a configuration of a printing system 1 according to the present embodiment.

The printing system 1 is provided with a printer 100, a server device 200, and a client terminal device 300. The printer 100, the server device 200, and the client terminal device 300 are connected to each other via a network NW so as to be able to communicate with each other. The network NW is, for example, a WAN (Wide Area Network).

The printer 100 prints an image on a recording medium M. In the present embodiment, there is described when the printer 100 is, for example, a so-called inkjet-type large-format printer. Further, when an error occurs, the printer 100 transmits error information ER to the server device 200. Further, the printer 100 regularly (e.g., once per day) transmits an operation log PL to the server device 200.

The printer 100 corresponds to an example of a “printing device.”

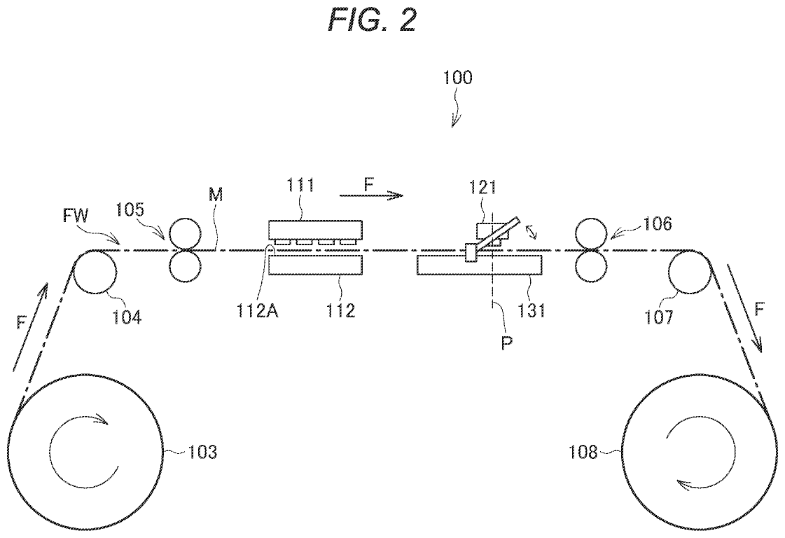

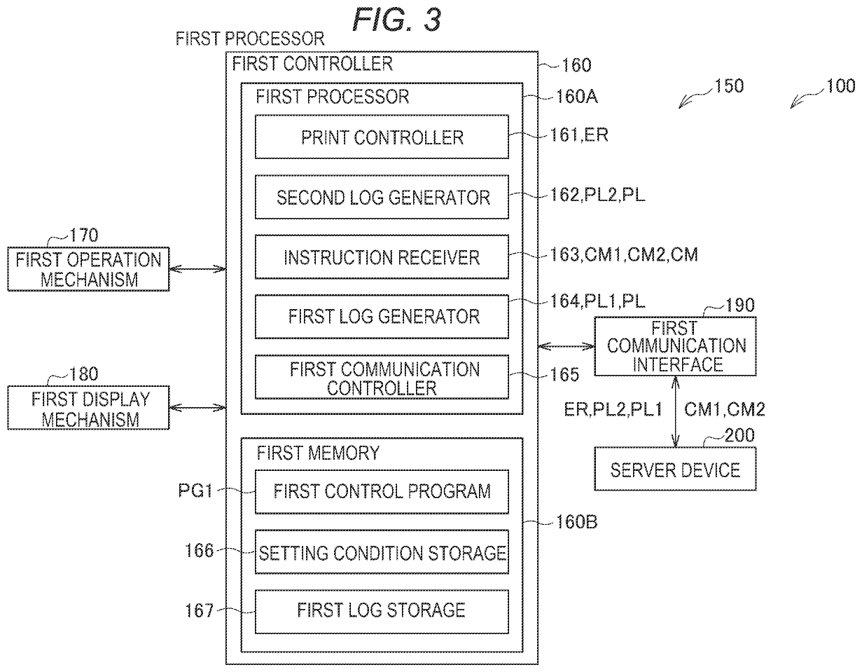

The printer 100 will further be described with reference to FIG. 2 and FIG. 3.

In the present embodiment, there is described when the printing system 1 includes a single printer 100 for the sake of convenience, but this is not a limitation. It is possible for the printing system 1 to include a plurality of printers 100.

Further, in the present embodiment, there is described when the printer 100 is the inkjet-type large-format printer, but the printer 100 can be a so-called business printer, or a home printer.

The server device 200 regularly receives the operation log PL from the printer 100. Further, the server device 200 transmits the operation log PL to the client terminal device 300.

Further, when the server device 200 receives the error information ER from the printer 100, the server device 200 transmits an instruction CM of setting a predetermined setting condition and executing a printing operation to the printer 100.

In the present embodiment, there is described when the server device 200 is connected to the printer 100 and the client terminal device 300 with an Ethernet (a registered trademark) cable or the like so as to be able to achieve wired communication with each other, but this is not a limitation. It is possible for the server device 200 to be connected to the printer 100 and the client terminal device 300 with Wi-Fi (a registered trademark) or the like so as to be able to achieve wireless communication with each other.

The client terminal device 300 is constituted by, for example, a personal computer, and receives the error information ER and the operation log PL from the server device 200. The user (e.g., a designer of the printer 100 or a maintenance staff of the printer 100) of the client terminal device 300 analyzes the operation log PL to identify the cause of the error information ER.

When the cause of the error cannot be identified, the user operates the client terminal device 300 to make the client terminal device 300 transmit identification-failure information NS to the server device 200. The identification-failure information NS represents that the cause of the error cannot be identified.

When the server device 200 receives the identification-failure information NS, the server device 200 transmits an instruction CM of setting a predetermined setting condition and executing a printing operation to the printer 100.

In the present embodiment, there is described when the printing system 1 includes a single client terminal device 300 for the sake of convenience, but this is not a limitation. It is possible for the printing system 1 to include a plurality of client terminal devices 300.

Further, in the present embodiment, there is described when the client terminal device 300 is constituted by a personal computer, but this is not a limitation. It is possible for the client terminal device 300 to be constituted by a smartphone, a tablet terminal, or the like.

### 2. Configuration of Printer

Then, a configuration of the printer 100 will be described with reference to FIG. 2. FIG. 2 is a side view showing an example of the configuration of the printer 100 according to the present embodiment.

The printer 100 is an inkjet-type large-format printer which ejects ink to the recording medium M to form an image on a printing surface of the recording medium M.

The printer 100 is provided with a print head 111 for ejecting the ink to the recording medium M. The printer 100 ejects a plurality of colors of ink from the print head 111 to thereby perform color printing. For example, the print head 111 ejects the five colors of ink, namely yellow ink, magenta ink, cyan ink, black ink, and white ink, from respective nozzles different from each other. The number of colors of the ink used by the printer 100 is not particularly limited. A platen 112 is arranged at a position opposed to the print head 111. The platen 112 supports the recording medium M at a position opposed to the print head 111 in a support surface 112A formed like a plane.

The recording medium M is not particularly limited as long as the recording medium M has a sheet-like shape, and it is possible to use paper, a sheet made of synthetic resin, cloth, and so on. The recording medium M can be a cut sheet cut to have a standard size, but in the present embodiment, there is described a configuration in which a long recording medium M is used.

The printer 100 has a delivery roller 103 on which the recording medium M is wound around to form a roll shape. The printer 100 includes conveying rollers 105 and conveying rollers 106 for conveying the recording medium M delivered from the delivery roller 103.

Each of the conveying rollers 105 and the conveying rollers 106 nip the recording medium M with a pair of rollers to feed the recording medium M in a conveying direction F. The recording medium M printed by the print head 111 is wound by a wind-up roller 108. The conveying rollers 105 and the conveying rollers 106 are driven by a conveying motor not shown. Further, the delivery roller 103 and the wind-up roller 108 are driven by the conveying motor or another motor.

The conveying rollers 105 and the conveying roller 106 are arranged along a conveying path FW through which the recording medium M is conveyed in the printer 100, and convey the recording medium M in the conveying direction F in accordance with the control by a first controller 160 which will be described later with reference to FIG. 3. The printer 100 is provided with a relay roller 104 for guiding the recording medium M delivered from the delivery roller 103 to the conveying rollers 105, and a relay roller 107 for guiding the recording medium M to the wind-up roller 108. The relay roller 104 can be constituted by a plurality of rollers. The same applies to the relay roller 107.

The printer 100 has a colorimeter 121 for performing colorimetry on the recording medium M printed by the print head 111. The colorimeter 121 is located downstream of the print head 111 in the conveying direction F, and performs the colorimetry on a print image formed on the printing surface of the recording medium M using the ink ejected by the print head 111.

It should be noted that it is possible to dispose a configuration for fixing the ink between the print head 111 and the colorimeter 121. For example, when the printer 100 performs printing using UV ink which cures due to ultraviolet rays, it is possible to arrange an ultraviolet irradiation device at downstream of the print head 111 in the conveying direction F. In this case, the colorimeter 121 is arranged at downstream of the ultraviolet irradiation device. Further, in the printer 100, it is possible to arrange a drying device for drying the ink at downstream of the print head 111. In this case, the colorimeter 121 is arranged at downstream of the drying device.

In the present embodiment, a position where the colorimeter 121 performs the colorimetry is described as a colorimetry position P. The colorimetry position P represents a position in the conveying direction F. In FIG. 2, the colorimetry position P is located at downstream of the print head 111 in the conveying direction F, and is located at upstream of the conveying rollers 106.

Here, the print head 111 side of the recording medium M in a direction perpendicular to the support surface 112A of the platen 112 is described as an upper side of the conveying path FW. Each part of the colorimeter 121 is arranged at the upper side of the conveying path FW, and is opposed to a surface on which the print head 111 ejects the ink in the recording medium M.

The colorimeter 121 is arranged so as to be opposed to a support member 131. The support member 131 is located at an opposite side to the colorimeter 121 across the recording medium M, namely at a lower side of the conveying path FW. An upper surface of the support member 131 is shaped like a plane, and the upper surface of the support member 131 supports the recording medium M.

Then, a configuration of a first control device 150 of the printer 100 will be described with reference to FIG. 3. FIG. 3 is a diagram showing an example of the configuration of the first control device 150 of the printer 100.

The printer 100 is provided with the first control device 150. The first control device 150 is provided with the first controller 160, a first operation mechanism 170, a first display mechanism 180, and a first communication interface 190. The first controller 160 is provided with a first processor 160A and a first memory 160B. The first controller 160 controls operations of constituents of the printer 100 shown in FIG. 2. To the first controller 160, there are coupled the print head 111, the colorimeter 121, and a variety of motors not shown.

For example, the print head 111 ejects the ink in accordance with an instruction from the first controller 160 to form a print image on the recording medium M.

Further, for example, the colorimeter 121 performs the colorimetry with colorimetric element not shown in accordance with an instruction from the first controller 160, and then outputs a colorimetric value to the first controller 160.

The first processor 160A is formed of a CPU (Central Processing Unit), a DSP (Digital Signal Processor), a microcomputer, or the like. The first processor 160A can be formed of a plurality of processors, or can also be formed of a single processor.

It is also possible for the first processor 160A to be hardware programmed so as to realize functions of constituents described later. In other words, it is possible for the first processor 160A to have a configuration in which a first control program PG1 is implemented as a hardware circuit. In this case, for example, the first processor 160A is formed of an ASIC (application specific integrated circuit) or an FPGA (field programmable gate array).

In the following description, there is described when the first processor 160A executes the first control program PG1 to thereby realize a variety of functions of the first controller 160.

The first memory 160B has a storage area for storing a program to be executed by the first processor 160A, and data to be processed by the first processor 160A. The first memory 160B stores the first control program PG1 to be executed by the first processor 160A, setting data including a variety of setting values related to the printing operation of the printer 100, and so on.

The first memory 160B has a nonvolatile storage area for storing the program and the data in a nonvolatile manner. The first memory 160B can be provided with, for example, a ROM (Read Only Memory), an HDD (Hard Disk Drive), or an SSD (Solid State Drive) as the nonvolatile storage area. Further, it is possible for the first memory 160B to be provided with a volatile storage area to form a work area for temporarily storing the program to be executed by the first processor 160A and the data as the processing target. The first memory 160B can be provided with, for example, a RAM (Random Access Memory) as the volatile storage area.

Further, to the first controller 160, there are coupled the first operation mechanism 170, the first display mechanism 180, and the first communication interface 190.

Further, to the first controller 160, there are coupled a variety of sensors for performing detection related to the printing operation of the printer 100. For example, there are coupled a residual amount sensor for detecting a residual amount of the recording medium M wound around the delivery roller 103, and a medium sensor for detecting presence or absence of the recording medium M at detection positions at upstream and downstream of the platen 112. Further, it is possible to couple a variety of sensors for detecting clogging of the nozzles of the print head 111.

The first operation mechanism 170 is provided with a variety of keys, buttons, and so on, and receives operations from the user (e.g., an operator of the printer 100). Then, the first operation mechanism 170 generates an operation signal corresponding to the operation thus received, and then outputs the operation signal thus generated to the first controller 160. The first display mechanism 180 is provided with an LCD (Liquid Crystal Display) or the like, and displays a variety of images on the LCD in accordance with an instruction from the first controller 160.

The first communication interface 190 is provided with a connector and an interface circuit, and is coupled to the first controller 160. In the present embodiment, the first communication interface 190 is an interface for communicating with the server device 200 in accordance with, for example, the Ethernet (a registered trademark) standard.

Further, as shown in FIG. 3, the first controller 160 is provided with a print controller 161, a second log generator 162, an instruction receiver 163, a first log generator 164, a first communication controller 165, a setting condition storage 166, and a first log storage 167. These constituents are realized by cooperation of software and hardware by, for example, the first processor 160A executing the first control program PG1.

The setting condition storage 166 stores a setting condition. The setting condition includes setting values to be set to the constituents of the printer 100, and print image data. The setting condition includes the “predetermined setting condition.” The “predetermined setting condition” is stored by the instruction receiver 163 in the setting condition storage 166. Further, the “predetermined setting condition” is read out by the print controller 161, and is then set to the printer 100.

The first log storage 167 stores a first operation log PL1 and a second operation log PL2. The first operation log PL1 is generated by the first log generator 164, and the first operation log PL1 thus generated is stored in the first log storage 167. The second operation log PL2 is generated by the second log generator 162, and the second operation log PL2 thus generated is stored in the first log storage 167.

The print controller 161 makes the printer 100 execute the printing operation. Further, when an error occurs in the printer 100, the print controller 161 generates the error information ER, and then transmits the error information ER thus generated to the server device 200. The error information ER represents that the error has occurred. Further, it is possible for the error information ER to include information representing at least one of a type and a content of the error having occurred.

The second log generator 162 regularly (e.g., once a day) generates the second operation log PL2 as a log related to the usual printing operation of the printer 100. Further, the second log generator 162 makes the first log storage 167 store the second operation log PL2 thus generated. Further, the second log generator 162 transmits the second operation log PL2 to the server device 200. The “usual printing operation” means the printing operation other than the printing operation based on the instruction CM from the server device 200. In other words, the “usual printing operation” means the printing operation based on an instruction from the first control device 150.

The second operation log PL2 corresponds to an example of the operation log PL.

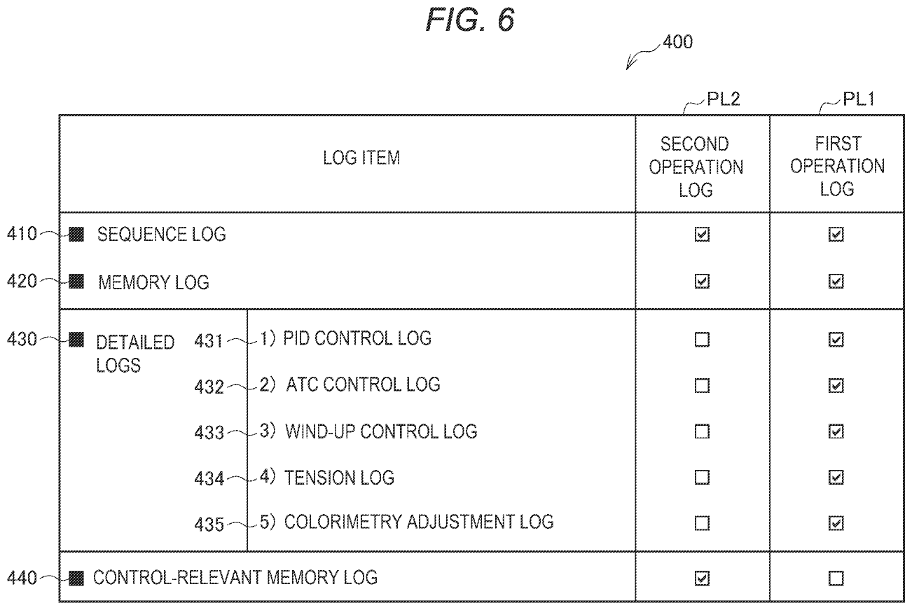

The second operation log PL2 will further be described with reference to FIG. 6.

The instruction receiver 163 receives a first instruction CM1 for setting the predetermined setting condition to the printer 100. When the instruction receiver 163 has received the first instruction CM1, the print controller 161 sets the predetermined setting condition to the printer 100. Further, the print controller 161 makes the setting condition storage 166 store the predetermined setting condition.

The “predetermined setting condition” is a setting condition for identifying, for example, the cause of the error corresponding to the error information ER. Further, the “predetermined setting condition” is a setting condition for replicating, for example, the error corresponding to the error information ER. The “predetermined setting condition” is transmitted, for example, from the client terminal device 300 to the server device 200.

Further, the instruction receiver 163 receives a second instruction CM2 of making the printer 100 perform the printing operation from the server device 200. When the instruction receiver 163 has received the first instruction CM1 and the second instruction CM2, the print controller 161 makes the printer 100 perform the printing operation.

The first instruction CM1 and the second instruction CM2 each correspond to an example of the instruction CM.

When the print controller 161 makes the printer 100 perform the printing operation based on the instruction CM from the server device 200, the first log generator 164 generates the first operation log PL1 as a detailed log related to the printing operation of the printer 100. Then, the first log generator 164 makes the first log storage 167 store the first operation log PL1 thus generated. Further, the first log generator 164 transmits the first operation log PL1 to the server device 200.

The first operation log PL1 corresponds to an example of the operation log PL.

The first operation log PL1 will further be described with reference to FIG. 6.

The first communication controller 165 controls the communication with the server device 200 via the first communication interface 190. The first communication controller 165 transmits, for example, the error information ER, the first operation log PL1, and the second operation log PL2 to the server device 200. Further, the first communication controller 165 receives, for example, the first instruction CM1 and the second instruction CM2 from the server device 200.

### 3. Configuration of Server Device

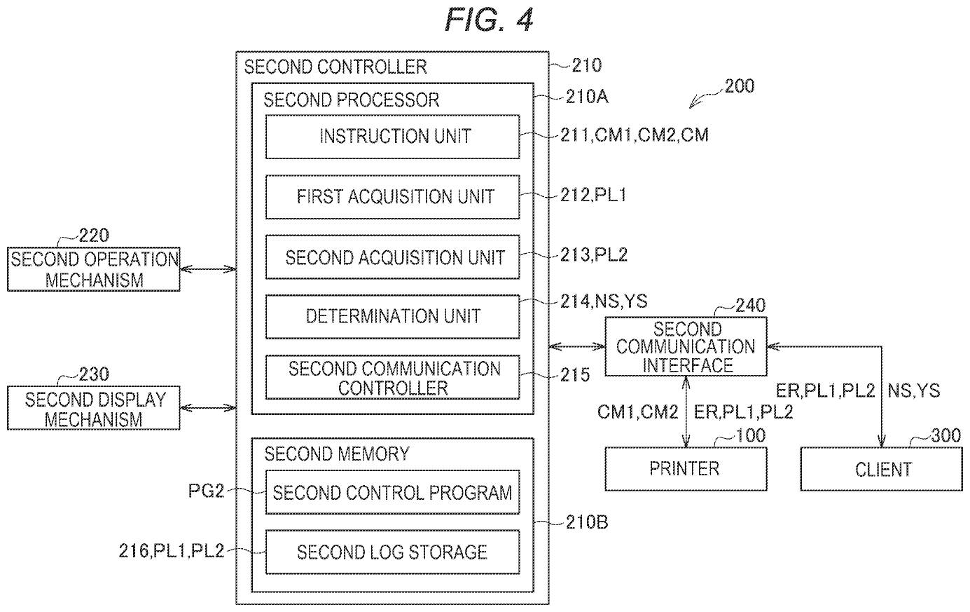

Then, a configuration of the server device 200 will be described with reference to FIG. 4. FIG. 4 is a diagram showing an example of the configuration of the server device 200 according to the present embodiment. As shown in FIG. 4, the server device 200 is provided with a second controller 210, a second operation mechanism 220, a second display mechanism 230, and a second communication interface 240. The second controller 210 is provided with a second processor 210A and a second memory 210B. The second controller 210 controls operations of constituents of the server device 200.

The second processor 210A is formed of a CPU, a DSP, a microcomputer, or the like. The second processor 210A can be formed of a plurality of processors, or can also be formed of a single processor.

It is also possible for the second processor 210A to be hardware programmed so as to realize functions of constituents described later. In other words, it is possible for the second processor 210A to have a configuration in which a second control program PG2 is implemented as a hardware circuit. In this case, for example, the second processor 210A is formed of an ASIC, an FPGA, or the like.

In the following description, there is described when the second processor 210A executes the second control program PG2 to thereby realize a variety of functions of the second controller 210.

The second memory 210B has a storage area for storing a program to be executed by the second processor 210A, and data to be processed by the second processor 210A. The second memory 210B stores the second control program PG2 to be executed by the second processor 210A, and a variety of types of image data, setting data, and so on related to operations of the server device 200.

The second memory 210B has a nonvolatile storage area for storing the program and the data in a nonvolatile manner. The second memory 210B can be provided with, for example, a ROM, an HDD, or an SSD as the nonvolatile storage area. Further, it is possible for the second memory 210B to be provided with a volatile storage area to form a work area for temporarily storing the program to be executed by the second processor 210A and the data as the processing target. The second memory 210B can be provided with, for example, a RAM as the volatile storage area.

Further, to the second controller 210, there are coupled the second operation mechanism 220, the second display mechanism 230, and the second communication interface 240.

The second operation mechanism 220 is provided with a variety of keys, buttons, and so on, and receives operations from the user (e.g., an administrator of the server device 200). Then, the second operation mechanism 220 generates an operation signal corresponding to the operation thus received, and then outputs the operation signal thus generated to the second controller 210.

The second display mechanism 230 is provided with an LCD or the like, and displays a variety of images on the LCD in accordance with an instruction from the second controller 210.

The second communication interface 240 is provided with a connector and an interface circuit, and is coupled to the second controller 210. In the present embodiment, the second communication interface 240 is an interface for communicating with each of the printer 100 and the client terminal device 300 in accordance with, for example, the Ethernet (a registered trademark) standard.

Further, as shown in FIG. 4, the second controller 210 is provided with an instruction unit 211, a first acquisition unit 212, a second acquisition unit 213, a determination unit 214, a second communication controller 215, and a second log storage 216. These constituents are realized by cooperation of software and hardware by, for example, the second processor 210A executing the second control program PG2.

The second log storage 216 stores the first operation log PL1 and the second operation log PL2. The first operation log PL1 is obtained by the first acquisition unit 212, and is stored by the first acquisition unit 212 in the second log storage 216. The second operation log PL2 is obtained by the second acquisition unit 213, and is stored by the second acquisition unit 213 in the second log storage 216.

When an error has occurred in the printer 100, the instruction unit 211 transmits the second instruction CM2 of making the printer 100 perform the printing operation.

“When an error has occurred in the printer 100” includes the following two cases. First, there is cited when the error information ER representing that the error has occurred has been received from the printer 100. Then, there is cited when the determination unit 214 has determined that the error has occurred in the printer 100 based on the second operation log PL2.

Further, when the instruction unit 211 receives the identification-failure information NS representing that the cause of the error corresponding to the error information ER cannot be identified from, for example, the client terminal device 300, the instruction unit 211 transmits the second instruction CM2 of making the printer 100 perform the printing operation.

Further, the instruction unit 211 transmits the first instruction CM1 of setting the predetermined setting to the printer 100 before transmitting the second instruction CM2 to the printer 100.

When the printer 100 receives the first instruction CM1, the printer 100 sets the predetermined setting. Further, when the printer 100 receives the second instruction CM2, the printer 100 performs the printing operation, and generates the first operation log PL1. Then, the printer 100 transmits the first operation log PL1 to the server device 200.

The first acquisition unit 212 makes the printer 100 generate the first operation log PL1, and then obtains the first operation log PL1 from the printer 100. Further, the first acquisition unit 212 makes the second log storage 216 store the first operation log PL1 thus obtained. Further, the first acquisition unit 212 transmits the first operation log PL1 thus obtained to the client terminal device 300.

The first operation log PL1 is a log related to the printing operation of the printer 100 based on the second instruction CM2. In other words, the first operation log PL1 is the operation log PL generated when the printer 100 performs the printing operation based on the second instruction CM2.

The second acquisition unit 213 obtains the second operation log PL2 from the printer 100. The second operation log PL2 is the operation log PL related to the usual printing operation of the printer 100. In the present embodiment, the second operation log PL2 is, for example, a regular operation log PL related to the printing operation of the printer 100. In other words, the second acquisition unit 213 regularly obtains the second operation log PL2 from the printer 100.

The second acquisition unit 213 makes the second log storage 216 store the second operation log PL2 thus obtained. Further, the second acquisition unit 213 transmits the second operation log PL2 thus obtained to the client terminal device 300.

The determination unit 214 determines whether or not an error has occurred in the printer 100 based on the second operation log PL2. The determination unit 214 determines whether or not the error has occurred in the printer 100 based on, for example, a reply from the client terminal device 300 to the second operation log PL2 which the second acquisition unit 213 has transmitted to the client terminal device 300. The reply from the client terminal device 300 is input to the client terminal device 300 by, for example, the designer of the printer 100 or the maintenance staff of the printer 100.

Further, when the determination unit 214 receives the error information ER from the printer 100, the determination unit 214 transmits the error information ER to the client terminal device 300. Then, when the determination unit 214 receives the identification-failure information NS from the client terminal device 300, the determination unit 214 determines that it is unachievable to identify the cause of the error corresponding to the error information ER. Further, when the determination unit 214 receives identification information YS from the client terminal device 300, the determination unit 214 determines that the cause of the error corresponding to the error information ER has successfully been identified. The identification information YS represents that the cause of the error corresponding to the error information ER has successfully been identified.

The second communication controller 215 transmits the first instruction CM1 and the second instruction CM2 to the printer 100. Further, the second communication controller 215 receives the error information ER, the first operation log PL1, and the second operation log PL2 from the printer 100.

Further, the second communication controller 215 transmits the error information ER, the first operation log PL1, and the second operation log PL2 to the client terminal device 300. Further, the second communication controller 215 receives the identification-failure information NS and the identification information YS from the client terminal device 300.

### 4. Configuration of Client Terminal Device

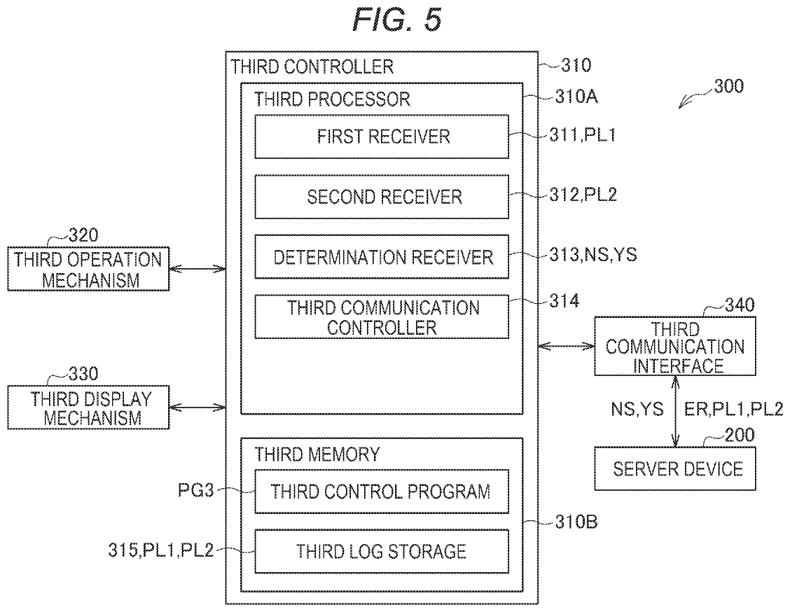

Then, a configuration of the client terminal device 300 will be described with reference to FIG. 5. FIG. 5 is a diagram showing an example of the configuration of the client terminal device 300. As shown in FIG. 5, the client terminal device 300 is provided with a third controller 310, a third operation mechanism 320, a third display mechanism 330, and a third communication interface 340. The third controller 310 is provided with a third processor 310A and a third memory 310B. The third controller 310 controls operations of constituents of the client terminal device 300.

The third processor 310A is formed of a CPU, a DSP, a microcomputer, or the like. The third processor 310A can be formed of a plurality of processors, or can also be formed of a single processor.

It is also possible for the third processor 310A to be hardware programmed so as to realize functions of constituents described later. In other words, it is possible for the third processor 310A to have a configuration in which a third control program PG3 is implemented as a hardware circuit. In this case, for example, the third processor 310A is formed of an ASIC, an FPGA, or the like.

In the following description, there is described when the third processor 310A executes the third control program PG3 to thereby realize a variety of functions of the third controller 310.

The third memory 310B has a storage area for storing a program to be executed by the third processor 310A, and data to be processed by the third processor 310A. The third memory 310B stores the third control program PG3 to be executed by the third processor 310A, and a variety of types of image data, setting data, and so on related to operations of the client terminal device 300.

The third memory 310B has a nonvolatile storage area for storing the program and the data in a nonvolatile manner. The third memory 310B can be provided with, for example, a ROM, an HDD, or an SSD as the nonvolatile storage area. Further, it is possible for the third memory 310B to be provided with a volatile storage area to form a work area for temporarily storing the program to be executed by the third processor 310A and the data as the processing target. The third memory 310B can be provided with, for example, a RAM as the volatile storage area.

Further, to the third controller 310, there are coupled the third operation mechanism 320, the third display mechanism 330, and the third communication interface 340.

The third operation mechanism 320 is provided with a mouse, a keyboard, and so on, and receives operations from the user (e.g., the designer of the printer 100, or the maintenance staff of the printer 100). Then, the third operation mechanism 320 generates an operation signal corresponding to the operation thus received, and then outputs the operation signal thus generated to the third controller 310.

The third display mechanism 330 is provided with an LCD or the like, and displays a variety of images on the LCD in accordance with an instruction from the third controller 310. The third display mechanism 330 displays images respectively representing, for example, the error information ER, the first operation log PL1, and the second operation log PL2 on the LCD.

The third communication interface 340 is provided with a connector and an interface circuit, and is coupled to the third controller 310. In the present embodiment, the third communication interface 340 is an interface for communicating with the server device 200 in accordance with, for example, the Ethernet (a registered trademark) standard.

Further, as shown in FIG. 5, the third controller 310 is provided with a first receiver 311, a second receiver 312, a determination receiver 313, a third communication controller 314, and a third log storage 315. These constituents are realized by cooperation of software and hardware by, for example, the third processor 310A executing the third control program PG3.

The third log storage 315 stores the first operation log PL1 and the second operation log PL2. The first operation log PL1 is received from the server device 200 by the first receiver 311, and is stored by the first receiver 311 in the third log storage 315. The second operation log PL2 is received from the server device 200 by the second receiver 312, and is stored by the second receiver 312 in the third log storage 315.

The first receiver 311 receives the first operation log PL1 from the server device 200. Then, the first receiver 311 makes the third log storage 315 store the first operation log PL1.

The second receiver 312 receives the second operation log PL2 from the server device 200. Then, the second receiver 312 makes the third log storage 315 store the second operation log PL2.

The determination receiver 313 receives a determination operation by the user (e.g., the designer of the printer 100 or the maintenance staff of the printer 100) on whether or not an error has occurred in the printer 100 based on the second operation log PL2 via the third operation mechanism 320. In other words, when the second receiver 312 has received the second operation log PL2, the user determines whether or not an error has occurred in the printer 100 based on the second operation log PL2. Then, the determination operation representing the determination result is input to the third operation mechanism 320. When the determination receiver 313 has received the determination operation representing that the error has occurred, information representing that the error has occurred is replied to the server device 200.

Further, when the determination receiver 313 has received the error information ER from the server device 200, the determination receiver 313 generates the information representing whether or not the cause of the error corresponding to the error information ER has successfully been identified based on the operation from the user. In other words, when the error information ER has been received from the server device 200, the user analyzes the cause of the error corresponding to the error information ER based on, for example, the second operation log PL2. Then, the user inputs the operation representing whether or not the cause of the error has successfully been identified to the third operation mechanism 320.

The information representing whether or not the cause of the error has successfully been identified includes the identification information YS and the identification-failure information NS. The identification information YS represents that the cause of the error has successfully been identified. The identification-failure information NS represents that the cause of the error cannot be identified. Further, the determination receiver 313 transmits the identification information YS or the identification-failure information NS to the server device 200.

The third communication controller 314 transmits, for example, the identification information YS and the identification-failure information NS to the server device 200. Further, the third communication controller 314 receives, for example, the error information ER, the first operation log PL1, and the second operation log PL2 from the server device 200.

### 5. First Operation Log and Second Operation Log

Then, the first operation log PL1 and the second operation log PL2 will be described with reference to FIG. 6. FIG. 6 is a diagram showing an example of the first operation log PL1 and the second operation log PL2.

As shown in FIG. 6, the second operation log PL2 includes a sequence log 410, a memory log 420, and a control-relevant memory log 440.

The sequence log 410 is a log representing an operation sequence of the printer 100. The memory log 420 and the control-relevant memory log 440 are each a log representing a control behavior of the printer 100.

The first operation log PL1 includes the sequence log 410, the memory log 420, and detailed logs 430. The detailed logs 430 include a PID (Proportional-Integral-Differential) control log 431, an ATC (Automatic Tension Control) control log 432, a wind-up control log 433, a tension log 434, and a colorimetry adjustment log 435.

The PID control log 431 is a log representing the behavior of the PID control with respect to the conveying speed of the recording medium M by the conveying rollers 105 and the conveying rollers 106 of the printer 100. The ATC control log 432 is a log representing the behavior of the control to the tension applied to the recording medium M between the conveying rollers 105 and the conveying rollers 106. The wind-up control log 433 is a log representing the behavior of the control to the tension applied to the recording medium M between the relay roller 107 and the wind-up roller 108. The tension log 434 is a log representing the behavior of the tension applied to the recording medium M between the conveying rollers 105 and the conveying rollers 106. The colorimetry adjustment log 435 is a log representing an adjustment result of the colorimeter 121.

As shown in FIG. 6, since the first operation log PL1 is more extensive compared to the second operation log PL2, by obtaining the first operation log PL1, it is possible to obtain items which cannot be obtained with the second operation log PL2. Specifically, as the detailed logs 430, the first operation log PL1 includes the PID control log 431, the ATC control log 432, the wind-up control log 433, the tension log 434, and the colorimetry adjustment log 435. Therefore, it becomes possible for the user (e.g., the designer of the printer 100 or the maintenance staff of the printer 100) to identify the cause of the error by analyzing the first operation log PL1.

In the present embodiment, there is described when the first operation log PL1 includes the PID control log 431, the ATC control log 432, the wind-up control log 433, the tension log 434, and the colorimetry adjustment log 435 as the detailed logs 430, but this is not a limitation. It is possible for the first operation log PL1 to include other logs in addition to the PID control log 431, the ATC control log 432, the wind-up control log 433, the tension log 434, and the colorimetry adjustment log 435 as the detailed logs 430. Further, it is also possible for the user (e.g., the designer of the printer 100 or the maintenance staff of the printer 100) to set the contents of the logs to be obtained as the first operation log PL1 to the printer 100 via the client terminal device 300 and the server device 200. In this case, it is possible to enhance the convenience of the user.

### 6. Processing of Controller

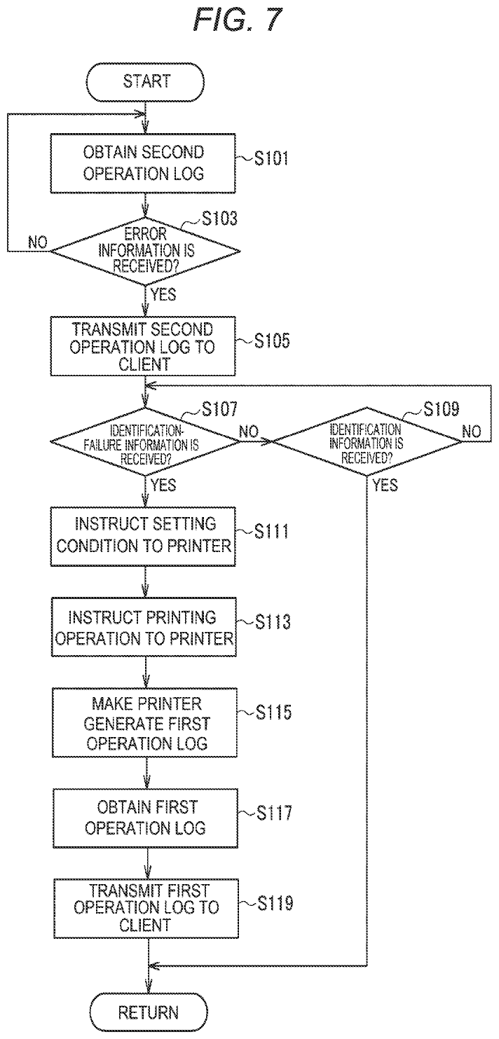

Then, the processing of the second controller 210 of the server device 200 will be described with reference to FIG. 7. FIG. 7 is a flowchart showing an example of the processing in the server device 200.

It should be noted that in FIG. 7, for the sake of convenience, there is described when the instruction unit 211 transmits the first instruction CM1 and the second instruction CM2 to the printer 100 when the instruction unit 211 receives the error information ER from the printer 100, and at the same time, receives the identification-failure information NS from the client terminal device 300.

As shown in FIG. 7, first, in the step S101, the second acquisition unit 213 obtains the second operation log PL2 from the printer 100.

Then, in the step S103, the instruction unit 211 determines whether or not the error information ER has been received from the printer 100.

When the instruction unit 211 has determined that the error information ER has not been received (NO in the step S103), the process returns to the step S101. When the instruction unit 211 has determined that the error information ER has been received (YES in the step S103), the process proceeds to the step S105.

Then, in the step S105, the second acquisition unit 213 transmits the second operation log PL2 to the client terminal device 300.

Then, in the step S107, the determination unit 214 transmits the error information ER to the client terminal device 300, and then determines whether or not the identification-failure information NS has been received from the client terminal device 300.

When the determination unit 214 has determined that the identification-failure information NS has been received (YES in the step S107), the process proceeds to the step S111. When the determination unit 214 has determined that the identification-failure information NS has not been received (NO in the step S107), the process proceeds to the step S109.

Then, in the step S109, the determination unit 214 determines whether or not the identification information YS has been received from the client terminal device 300.

When the determination unit 214 has determined that the identification information YS has not been received (NO in the step S109), the process returns to the step S107. When the determination unit 214 has determined that the identification information YS has been received (YES in the step S109), the process returns to the step S101.

When YES has been determined in the step S107, the instruction unit 211 transmits the first instruction CM1 of setting the predetermined setting to the printer 100 in the step S111.

Then, in the step S113, the instruction unit 211 transmits the second instruction CM2 of making the printer 100 perform the printing operation.

Then, in the step S115, the first acquisition unit 212 makes the printer 100 generate the first operation log PL1.

Then, in the step S117, the first acquisition unit 212 obtains the first operation log PL1 from the printer 100.

Then, in the step S119, the first acquisition unit 212 transmits the first operation log PL1 to the client terminal device 300. Subsequently, the process returns to the step S101.

It should be noted that the step S113 corresponds to an example of an “instruction step.” The step S117 corresponds to an example of a “first acquisition step.”

In FIG. 7, there is described when the instruction unit 211 transmits the first instruction CM1 and the second instruction CM2 to the printer 100 when the instruction unit 211 receives the error information ER, and at the same time, receives the identification-failure information NS, but this is not a limitation.

For example, it is possible for the instruction unit 211 to transmit the first instruction CM1 and the second instruction CM2 to the printer 100 when the instruction unit 211 receives the error information ER. Further, for example, it is possible for the instruction unit 211 to transmit the first instruction CM1 and the second instruction CM2 to the printer 100 when the instruction unit 211 receives the identification-failure information NS. Further, for example, it is possible for the instruction unit 211 to transmit the first instruction CM1 and the second instruction CM2 to the printer 100 when the instruction unit 211 transmits the first operation log PL1 to the client terminal device 300, and then receives the identification-failure information NS in response to the first operation log PL1.

### 7. Configuration and Advantages

As described hereinabove, the server device 200 according to the present embodiment is the server device 200 to be coupled to the printer 100 so as to be able to communicate with each other, and is provided with the instruction unit 211 configured to transmit the second instruction CM2 of making the printer 100 perform the printing operation when an error has occurred in the printer 100, and the first acquisition unit 212 configured to make the printer 100 generate the first operation log PL1 as a log related to the printing operation based on the second instruction CM2, and obtain the first operation log PL1 from the printer 100.

According to this configuration, when an error has occurred in the printer 100, the second instruction CM2 of making the printer 100 perform the printing operation is transmitted. Then, the printer 100 is made to generate the first operation log PL1 as the log related to the printing operation based on the second instruction CM2, and the first operation log PL1 is obtained from the printer 100.

Therefore, it is possible to make the printer 100 perform the printing operation using the second instruction CM2 from the server device 200. Further, it is possible to obtain the first operation log PL1 as the log related to the printing operation based on the second instruction CM2. Therefore, even when, for example, the user (e.g., the designer of the printer 100 or the maintenance staff of the printer 100) is located far from the place where the printer 100 is arranged, it is possible to obtain the items which cannot be obtained with the usual operation log (e.g., the operation log regularly obtained).

Further, in the server device 200, the instruction unit 211 transmits the second instruction CM2 of making the printer 100 perform the printing operation when the instruction unit 211 receives the error information ER representing that an error has occurred from the printer 100.

According to this configuration, when the error information ER is received, the second instruction CM2 of making the printer 100 perform the printing operation is transmitted.

Therefore, it is possible to make the printer 100 perform the printing operation using the second instruction CM2 when the error information ER is received. Further, it is possible to obtain the first operation log PL1 as the log related to the printing operation based on the second instruction CM2. Therefore, it is possible to obtain the items which cannot be obtained in the usual operation log.

Further, in the server device 200, the server device 200 is coupled to the client terminal device 300 so as to be able to communicate with each other, and when the instruction unit 211 has received the identification-failure information NS representing that the cause of the error corresponding to the error information ER cannot be identified from the client terminal device 300, the instruction unit 211 transmits the second instruction CM2 of making the printer 100 perform the printing operation.

According to this configuration, when the identification-failure information NS representing that the cause of the error corresponding to the error information ER cannot be identified is received, the second instruction CM2 of making the printer 100 perform the printing operation is transmitted.

Therefore, it is possible to make the printer 100 perform the printing operation using the second instruction CM2 when the identification-failure information NS is received. Further, it is possible to obtain the first operation log PL1 as the log related to the printing operation based on the second instruction CM2. Therefore, it is possible to obtain the items which cannot be obtained in the usual operation log.

Further, in the server device 200, there are further provided the second acquisition unit 213 configured to obtain the second operation log PL2 as a log related to the usual printing operation of the printer 100, and the determination unit 214 configured to determine whether or not an error has occurred in the printer 100 based on the second operation log PL2, wherein the instruction unit 211 transmits the second instruction CM2 of making the printer 100 perform the printing operation when the determination unit 214 has determined that an error has occurred in the printer 100.

According to this configuration, whether or not an error has occurred in the printer 100 is determined based on the second operation log PL2, and when it is determined that the error has occurred in the printer 100, the second instruction CM2 of making the printer 100 perform the printing operation is transmitted.

Therefore, it is possible to make the printer 100 perform the printing operation using the second instruction CM2 when it is determined that the error has occurred in the printer 100. Further, it is possible to obtain the first operation log PL1 as the log related to the printing operation based on the second instruction CM2. Therefore, it is possible to obtain the items which cannot be obtained in the usual operation log.

Further, in the server device 200, the second acquisition unit 213 is configured to regularly obtain the second operation log PL2 as a log related to the usual printing operation of the printer 100.

According to this configuration, the second operation log PL2 as the log related to the usual printing operation of the printer 100 is regularly obtained.

Therefore, it is possible to regularly obtain the second operation log PL2 as the log related to the usual printing operation of the printer 100. Therefore, it is possible to regularly determine whether or not an error has occurred in the printer 100 based on the second operation log PL2.

Further, in the server device 200, the first operation log PL1 is more extensive than the second operation log PL2.

According to this configuration, the first operation log PL1 is more extensive than the second operation log PL2.

Therefore, by obtaining the first operation log PL1, it is possible to obtain the items which cannot be obtained with the second operation log PL2 as the log related to the usual printing operation.

Further, in the server device 200, the instruction unit 211 transmits the first instruction CM1 of setting the predetermined setting to the printer 100 before transmitting the second instruction CM2 of making the printer 100 perform the printing operation.

According to this configuration, the first instruction CM1 of setting the predetermined setting to the printer 100 is transmitted before transmitting the second instruction CM2 of making the printer 100 perform the printing operation.

Therefore, it is possible for the user (e.g., the designer or the maintenance staff of the printer 100) to set the desired setting to the printer 100.

A method of controlling the server device 200 according to the present embodiment is a method of controlling the server device 200 to be coupled to the printer 100 so as to be able to communicate with each other, including an instruction step of transmitting the second instruction CM2 of making the printer 100 operate when an error has occurred in the printer 100, and a first acquisition step of making the printer 100 generate the first operation log PL1 as a log related to the printing operation based on the second instruction CM2, and obtaining the first operation log PL1 from the printer 100.

According to the method of controlling the server device 200 related to the present embodiment, substantially the same functions and advantages as those of the server device 200 according to the present embodiment are exerted.

The printing system 1 according to the present embodiment is the printing system 1 provided with the printer 100, and the server device 200 to be coupled to the printer 100 so as to be able to communicate with each other, wherein the server device 200 includes the instruction unit 211 configured to transmit the second instruction CM2 of making the printer 100 perform the printing operation when an error has occurred in the printer 100, and the first acquisition unit 212 configured to make the printer 100 generate the first operation log PL1 as a log related to the printing operation based on the second instruction CM2, and obtain the first operation log PL1 from the printer 100.

According to the printing system 1 related to the present embodiment, substantially the same functions and advantages as those of the server device 200 according to the present embodiment are exerted.

### 8. Other Embodiments

The embodiment described above is for illustrating an aspect of the present disclosure, and can arbitrarily be modified or applied within the scope or the spirit of the present disclosure.

For example, there is described when the recording medium M is long, and the recording medium M is wound to form a roll shape, but this is not a limitation. The recording medium M can be a cut sheet cut to have a standard size.

Further, there is described when the print head 111 ejects the five colors of ink from the nozzles, but this is not a limitation. It is sufficient for the print head 111 to eject the ink from the nozzles. For example, it is possible to adopt a configuration in which the print head 111 ejects single color ink from the nozzle.

Further, for example, the processing units of the flowchart shown in FIG. 7 are obtained by dividing the processing of the second controller 210 of the server device 200 in accordance with major processing contents in order to make the processing easy to understand, and the present disclosure is not at all limited by the way of dividing the processing into the processing units or the names of the processing units. It is possible to divide the processing into a larger number of processing units in accordance with the processing contents. Further, it is also possible to divide the processing so that each of the processing units includes a larger amount of processing. Further, the order of the processing units can also be arbitrarily exchanged within a range in which no problem is posed in the scope or the spirit of the present disclosure.

Further, each of the functional units shown in FIG. 3 through FIG. 5 is for representing the functional configuration, and the specific implementation configuration is not particularly limited. In other words, it is not necessarily required to install the hardware individually corresponding to each of the constituents, but it is possible to adopt a configuration of realizing the functions of the plurality of constituents by a single processor executing a program. Further, a part of the functions realized by software in the embodiment described above can also be realized by hardware, or a part of the functions realized by hardware can also be realized by software. Besides the above, the specific detailed configuration of each of the other constituents of the printer 100, the server device 200, and the client terminal device 300 can arbitrarily be modified within the scope or the spirit of the present disclosure.

Further, the functional blocks of the server device 200 and the second controller 210 shown in FIG. 4 can be realized by making the second processor 210A provided to the second controller 210 of the server device 200 execute the second control program PG2 stored in the second memory 210B. Further, it is also possible to record the second control program PG2 on a recording medium storing the second control program PG2 in a computer-readable manner.

As the recording medium, there can be used a magnetic or optical recording medium, or a semiconductor memory device. Specifically, there can be cited a portable or rigid recording medium such as a flexible disk, an HDD (Hard Disk Drive), a CD-ROM (Compact Disc Read Only Memory), a DVD (Digital Versatile Disc), a Blu-ray (a registered trademark) disc, a magnetooptic disc, a flash memory, or a card-type recording medium. Further, the recording medium can also be a RAM, or a nonvolatile storage device such as a ROM or the HDD as an internal storage device provided to the second controller 210 of the server device 200. Further, it is also possible to realize the functional blocks of the second controller 210 of the server device 200 by storing the second control program PG2 in another server device or the like in advance, and then downloading the second control program PG2 into the second controller 210 of the server device 200 from the other server device.

What is claimed is:

1. A server device to be coupled to a printer so as to communicate with each other, the server device comprising:
an instruction unit configured to transmit an instruction of making the printer perform a printing operation when an error occurs in the printer; and
a first acquisition unit configured to make the printer generate a first operation log as a log related to the printing operation based on the instruction, and then obtain the first operation log from the printer.

2. The server device according to claim 1, wherein
the instruction unit transmits the instruction of making the printer perform the printing operation when error information representing that the error occurs is received from the printer.

3. The server device according to claim 2, wherein
the server device is coupled to a client terminal device so as to communicate with each other, and
when identification-failure information representing that a cause of the error corresponding to the error information fails to be identified is received from the client terminal device, the instruction unit transmits the instruction of making the printer perform the printing operation.

4. The server device according to claim 1, further comprising:
a second acquisition unit configured to obtain a second operation log as a log related to a usual printing operation of the printer; and
a determination unit configured to determine whether or not an error occurred in the printer based on the second operation log, wherein
when the determination unit determines that an error occurred in the printer, the instruction unit transmits the instruction of making the printer perform the printing operation.

5. The server device according to claim 4, wherein
the second acquisition unit regularly obtains the second operation log as the log related to the usual printing operation of the printer.

6. The server device according to claim 4, wherein
the first operation log is more extensive than the second operation log.

7. The server device according to claim 1, wherein
the instruction unit transmits an instruction of setting a predetermined setting to the printer before transmitting the instruction of making the printer perform the printing operation.

8. A method of controlling a server device to be coupled to a printer so as to communicate with each other, the method comprising:
an instruction step of transmitting an instruction of making the printer perform a printing operation when an error occurs in the printer; and
a first acquisition step of making the printer generate a first operation log as a log related to the printing operation based on the instruction, and then obtaining the first operation log from the printer.

9. A printing system comprising:
a printer; and
a server device coupled to the printer so as to communicate with each other, wherein
the server device includes
an instruction unit configured to transmit an instruction of making the printer perform a printing operation when an error occurs in the printer, and
a first acquisition unit configured to make the printer generate a first operation log as a log related to the printing operation based on the instruction, and then obtain the first operation log from the printer.
